(19) United States
(12) Patent Application Publication
(10) Pub. No.: US 2005/0246407 A1
(43) Pub. Date: Nov. 3, 2005

(54) High speed multiplication apparatus of Wallace tree type with high area efficiency

(75) Inventor: Niichi Itoh, Hyogo (JP)

Correspondence Address: MCDERMOTT WILL & EMERY LLP, 600 13TH STREET, N.W., WASHINGTON, DC, 20005-3096, US

(73) Assignee: Renesas Technology Corp., Tokyo (JP)

(21) Appl. No.: 11/174,544

(22) Filed: Jul. 6, 2005

Related U.S. Application Data
(62) Division of application No. 09/756,269, filed on Jan. 9, 2001.

(30) Foreign Application Priority Data
Jan. 13, 2000 (JP) 2000-004366 (P)

(51) Int. Cl. G06F 7/52

(52) U.S. Cl. 708/620

(57) ABSTRACT

A multiplication array is divided into divided Wallace tree arrays each performing multiplication by addition in a tree-like form. An addition result is transmitted from the divided Wallace tree arrays to a final addition circuit. Thus, an interconnection line length of a critical path of a multiplication apparatus can be reduced.

### BACKGROUND OF THE INVENTION

1. Field of the Invention

The present invention relates to multiplication apparatuses and, more specifically to a multiplication apparatus of a Wallace tree type for encoding a multiplier in accordance with a Booth algorithm and adding partial products using a Wallace tree type addition circuit for obtaining a product of the multiplier and a multiplicand.

2. Description of the Background Art

Multiplication is one of the most frequently performed operations in an arithmetic processing unit using a computer or the like. A high speed multiplication apparatus is indispensable for a high speed arithmetic processing system. Among various types of multiplication apparatuses, those using a carry save method and a Wallace tree are widely known.

FIG. 12A is a diagram schematically showing an arrangement of a portion of a conventional parallel multiplication circuit. FIG. 12A shows a portion for performing 4-bit multiplication of multiplier bits of Y(j−1) to Y(j+2) and multiplicand bits of X(i−1) to X(i+2).

Referring to FIG. 12A, multiplication unit circuits UM are arranged at intersections of multiplier bits of Y(j−1) to Y (j+2) and multiplicand bits of X(i−1) to X(i+2), respectively. The rows of multiplication unit circuits arranged corresponding to multiplier bits of Y(j−1) to Y(j+2) produce partial products PP0-PP3. The partial products PP0-PP3 are aligned in digit position and added to produce a multiplication result of multiplier bits of Y(j−1) to Y(j+2) and multiplicand bits of X(i−1) to X(i+2). Still referring to FIG. 12A, multiplication unit circuits UM arranged in a column direction (a longitudinal direction in FIG. 12A) are aligned at the same digit. A carry of each multiplication unit circuit UM is applied to multiplication unit circuit UM at the next upper digit.

FIG. 12B is a diagram schematically showing an arrangement of multiplication unit circuit UM shown in FIG. 12A. Referring to FIG. 12B, multiplication unit circuit UM includes: an AND circuit 900 receiving a multiplier bit Yb and a multiplicand bit Xa; and a full adder 902 adding an output bit from AND circuit 900, a sum output Sin of the preceding multiplication unit circuit, and a carry input Cin from the multiplication unit circuit at the lower digit in the same stage (row) to produce a sum output S and a carry output Cout. A multiplication result Xa·Yb of bits Xa and Yb is output from AND circuit 900.

A parallel multiplication circuit shown in FIG. 12A including multiplication unit circuits shown in FIG. 12B arranged in an array merely multiplies and adds multiplicand bits of X(i−1) to X(i+2) and multiplier bits of Y(j−1) to Y(j+2). The parallel multiplication circuit shown in FIG. 12A is simply obtained by regularly arranging multiplication unit circuits UM shown in FIG. 12B in an array. Therefore, it is suited for an integrated circuit because layout is simple and a time required for designing can be reduced.

In the parallel multiplication circuit of the carry save method, the carry is transmitted to the upper digit and not transmitted in the same column (a partial product) for a high speed operation. However, since the computation time is proportional to the bit number of multiplier Y (the number of partial products is proportional to the number of multiplier bits), multi-bit multiplication takes a considerable computation time. The parallel multiplication circuit shown in FIG. 12A is not suited for a microprocessor or the like, which requires an operation of multiple bits of, for example, 54 bits.

To overcome the deficiency of the parallel multiplication circuit described with reference to FIG. 12A, a method called an intra-digit parallel addition method is used to enhance parallelism in computation.

FIG. 13 is a diagram schematically showing another arrangement of a conventional parallel multiplication circuit. FIG. 13 also shows a portion of four bits of Y(j−1) to Y(j+2) of a multiplier Y and bits of X(i−1) to X(i+2) of a multiplicand X. In the parallel multiplication circuit shown in FIG. 13, in each of addition stages P0-P3, a sum output representing the addition result is applied to multiplication unit circuit UM in the second next stage, rather than in the next stage. In other words, the sum output is transmitted skipping one addition stage. The parallel multiplication circuit shown in FIG. 13 increases the number of additions which can be performed in parallel in the same digit, aiming a high speed operation. This scheme is generally referred to as an intra-digit parallel addition method. In the carry save method, a carry in each addition stage is applied to a multiplying unit cell at the adjacent upper digit of the next addition stage, and the carry is not transmitted in the same addition stage.

However, the structure shown in FIG. 13 requires twice as long a signal line for transmitting a sum output from each multiplication unit circuit as that of the parallel multiplication circuit shown in FIG. 12A (this is because the sum output must be transmitted over a distance corresponding to two addition stages). It is generally known that a line delay is proportional to the second power of the interconnection line length. Thus, the line delay of the structure shown in FIG. 13 is twice that of the parallel multiplication circuit shown in FIG. 12A. A structure of dividing the multiplication apparatus array into two portions has been proposed in, for example, Japanese Patent Laying-Open No. 63-55627 to reduce a line delay of a multiplication circuit of the intra-digit parallel addition method.

FIG. 14 is a diagram schematically showing an arrangement of a multiplication apparatus disclosed in the aforementioned laid-open application No. 63-55627. Referring to FIG. 14, a multiplication array is divided into two blocks BL1 and BL2, and a final stage addition circuit FSA is arranged between multiplication blocks BL1 and BL2. Block BL1 performs multiplication, through a partial product addition, on multiplicand bits of X0 to Xn and multiplier bits of Y0 to Y(n/2). Multiplication block BL2 performs addition of partial products of multiplier bits of Y((n/2)−3) to Yn and multiplicand bits of X0 to Xn.

In each of blocks BL1 and BL2, a multiplication circuit of a carry save addition method is formed. A carry output from each unit multiplication circuit is applied to a unit multiplication circuit at the next upper digit of an addition circuit in the next stage. Blocks BL1 and BL2 independently perform multiplication, and intermediate multiplication results of blocks BL1 and BL2 are added in final stage addition circuit FSA to produce an output representing a multiplication result of multiplier Y and multiplicand X.

In multiplication blocks BL1 and BL2, the number of stages Pj−1 to Pj, Pk−1 to Pk+2, to which the sum output is transmitted, is decreased to intend eliminating any influence of the line delay for high speed multiplication. In the structure shown in FIG. 14, however, addition circuits must be provided corresponding to bits of multiplier Y in both multiplication blocks BL1 and BL2. In addition, the carry is transmitted over each addition circuit, so that the speed is restricted.

The aforementioned laid-open application No. 63-55627 discloses that a Booth algorithm is utilized to reduce the number of stages of the addition circuits. However, even when the Booth algorithm is used, the multiplication array is of the carry save method, whereby the number of stages of the addition circuits is merely reduced and the improvement in speed of the operation is restricted. In the multiplication apparatus performing multiple bit multiplication using, for example, 54 bits, the carry save addition method including the schemes used in the structure in FIG. 14 is barely used. The aforementioned laid-open application No. 63-55627 only discloses a divided structure of the multiplication array, but not a specific arrangement as to how multiplier Y and multiplicand X are applied to divided multiplication blocks BL1 and BL2.

FIG. 15 is a diagram schematically showing an entire configuration of a conventional Wallace tree type multiplication apparatus, which is disclosed in a Japanese Patent Laying-Open No. 9-231056, for example. Referring to FIG. 15, the Wallace tree type multiplication apparatus includes a multiplicand register circuit 1101 for storing a multiplicand X, a multiplier register circuit 1102 for storing a multiplier Y, a Booth encoder 1103 for encoding the multiplier Y received from multiplier register circuit 1102 in accordance with a predetermined Booth algorithm, partial product generating circuits 1113 to 1120 provided corresponding to select control signals 1104 to 1111 from Booth encoder 1103 respectively, for generating partial products in accordance with the multiplicand X from multiplicand register circuit 1101 and respective select control signals 1104 to 1111, a Wallace tree portion 1129 for adding the partial products 1121 to 1128 received from partial product generating circuits 1113 to 1120, and a final adding portion 1131 for adding two intermediate multiplication results 1130 generated from Wallace tree portion 1129 to produce a final product representing the multiplication value of multiplicand X and multiplier Y.

Booth encoder 1103 includes Booth encode circuits 1045 to 1052 each arranged corresponding to a prescribed number of bits of multiplier Y for performing encoding operations in accordance with a prescribed Booth algorithm. Partial product generating circuit 1113 to 1120 generate candidate bits in accordance with the prescribed Booth algorithm for bits of multiplicand X and select candidate bits in accordance with select control signals 1104 to 1111 from corresponding Booth encode circuits 1045 to 1052 for generating partial products.

A Wallace tree portion 1129 sequentially reduces the number of partial products 1121 to 1128 in a tree-like form for addition. As a result, eight partial products 1121 to 1128 are reduced to provide two intermediate products 1130. The bits of multiplier Y are compressed in accordance with the Booth algorithm, and the number of generated partial products is reduced. Thereafter, the number of partial products is reduced at Wallace tree portion 1129 at each stage for a high speed operation.

FIG. 16 is a diagram schematically showing an arrangement of Wallace tree portion 1129 shown in FIG. 15. Wallace tree portion 1129 in FIG. 16 includes: 4:2 addition circuits 1138 and 1139 for adding partial products (hereinafter referred to as the 0-th order partial products) 1121-1124 and 1125-1128 generated by partial product generating circuits 1113 to 1120; and a 4:2 addition circuit 1140 adding outputs from 4:2 addition circuits 1138 and 1139 for generating two intermediate products 1130. 4:2 addition circuit 1138 adds the 0-th order partial products 1121 to 1124 for outputting two intermediate products 1141. 4:2 addition circuit 1139 adds the 0-th order partial products 1125 to 1128 for generating an intermediate product 1142. 4:2 addition circuits 1138 and 1139 each are an addition circuit of 4 inputs (I1 to I4) and 2 outputs (C and S) to provide two partial products at the respective outputs C and S. 4:2 addition circuit 1140 is also an addition circuit of 4 inputs (I1 to I4) and 2 outputs (C and S), and adds outputs from 4:2 for addition circuits 1138 and 1139 for generating two intermediate products 1130. The partial products PP1 and PP2 are generated at the respective outputs C and S.

Thus, eight partial products can be added in the tree-like form at addition circuits 1138 and 1139 in two stages to generate intermediate products 1130 for application to a final adding portion 1131. Booth encoder 1103 reduces the bit number of multiplier Y in accordance with the algorithm (the number is halved in the case of the second order Booth algorithm). Accordingly, by utilizing the Booth algorithm and the Wallace tree structure, eight 0-th order partial products are compressed to the four first order partial products, and then four partial products are compressed to two intermediate products. Thus, the number of stages of the addition circuits is reduced for a high speed operation.

FIG. 17 is a diagram schematically showing an arrangement of 4:2 addition circuit 1138 shown in FIG. 16. Referring to FIG. 17, 4:2 addition circuit 1138 includes 4-input, 2-output adding elements AE1 to AEn of n bits. Each of adding elements AE1 to AEn receives, at respective inputs I1 to I4, four bits at the same digit of the 0-th order partial products 1124 to 1121, and further receives a carry output C0 of the adding element in the preceding stage at carry input C1 for outputting 2-bit addition results C and S. As to the 2-bit addition result, lower and upper bits are represented by the outputs S and C, respectively. 2-bit outputs from adding elements AE1 to AEn are output as the 0-th order partial products 1141 in parallel with each other. The carry is transmitted through these adding elements AE1 to AEn.

By performing sequential multiplication using the above described Wallace tree, eight 0-th order partial products are compressed to four first order partial products. Thereafter, these four first order partial products are compressed to two second order partial products (intermediate products). Thus, the number of stages of the addition circuits can considerably be reduced as compared with the case of the parallel multiplication circuits of the carry save method.

It is noted that the specific structure of the above mentioned 4-input, 2-output adding element is exemplified in the aforementioned laid-open application No. 9-231056.

In computer systems, generally, multiplication using a plurality of bits, such as 32 bits, 54 bits, or more is performed. A possible configuration, which may be obtained when the Wallace tree type array structure using the 4:2 addition circuits is applied to the 54-bit multiplication apparatus, is shown in FIG. 18. Referring to FIG. 18, the Wallace tree type multiplication apparatus includes: a Booth encoder 1 encoding multiplier Y in accordance with a Booth algorithm for generating select control signals; a multiplicand register circuit 2 storing multiplicand X; Booth selectors 3a to 3α arranged corresponding to select control signals from Booth encoder 1 and generating the 0-th order partial products in accordance with multiplicand X from a multiplicand register circuit 2 and corresponding select control signals; the first order 4:2 addition circuits 4a to 4g adding the 0-th order partial products for generating the first order partial products; the second order 4:2 addition circuits 5a to 5e adding the first order partial products from addition circuits 4a to 4b for generating the second order partial products; the third order 4:2 addition circuits 6a and 6b adding the second order partial products from the second order 4:2 addition circuits 5a to 5e for generating the third order partial products; and a final addition circuit 7 adding the third order partial products (final intermediate products) from addition circuits 6a and 6b for outputting a final addition result, i.e., a product Z of multiplier Y and multiplicand X.

In FIG. 18, multiplier Y and multiplicand X both are assumed to have 54 bits. In the case of the second order Booth algorithm, the number of partial products is reduced to half the bit number of multiplier Y. Here, the second order Booth algorithm is generally represented by the following equation.
Z=X·Σ(y(2j)+y(2j+1)−2 y(2j+2)·2^{2j}

Here, summation is performed on j=0 to n/2−1. In other words, consecutive 3 bits of multiplier Y are simultaneously considered and multiplied by multiplicand X, so that the partial products can be halved in number. In addition, the partial product to be added may be any of ±2·X ±X and 0 in accordance with consecutive 3 bits y(2j), y(2j+1), and y(2j+2). Booth selectors 3a-3α generate partial products designated by the select control signals by shifting/inverting multiplicand X in accordance with the select control signals from Booth encode circuits 1a-1α included in Booth encoder 1. Here, 2·X is implemented by 1-bit left shifting operation, and −X is implemented by adding 1 to an inverted value of all bits by 2's complement operation.

The 0-th order partial products generated by Booth selectors 3a to 3a are added by the first order 4:2 addition circuits 4a to 4g, respectively. In other words, the 0-th order partial products generated by Booth selectors 3a and 3b are added by the first order 4:2 addition circuit 4a. The 0-th order partial products generated by Booth selectors 3c to 3f are added by the first order 4:2 addition circuit 4b. The 0-th order partial products generated by Booth selectors 3b to 3j are added by the first order addition circuit 3k. The 0-th order partial products generated by Booth selectors 3k to 3n are added by the first order 4:2 addition circuit 4b.

The 0-th order partial products generated by Booth selectors 3o to 3r are added by the first order 4:2 addition circuit 4e. The 0-th order partial products generated by Booth selectors 3s to 3v are added by the first order 4:2 addition circuit 4f. The 0-th order partial products generated by Booth selectors 3w to 3z are added by the first order 4:2 addition circuit 4g. Addition is not performed on the 0-th order partial product generated by Booth selector 3a.

The first order partial products generated by the first order 4:2 addition circuits 4a and 4b are added by the second order 4:2 addition circuit 5a. The first order partial products generated by the first order 4:2 addition circuits 4c and 4d are added by the second order 4:2 addition circuit 5b. The first order partial products generated by the first order 4:2 addition circuits 4e and 4f are added by the second order 4:2 addition circuit 5c. The first order partial product generated by the first order 4:2 addition circuit 4g and the 0-th order partial product generated by Booth selector 3a are added by the second order 4:2 addition circuit 5e.

The second order partial products generated by the second order 4:2 addition circuits 5a and 5b are added by the third order 4:2 addition circuit 6a. The second order partial products generated by the second order 4:2 addition circuits 5c and 5d are added by the third order 4:2 addition circuit 6b.

The third order partial products generated by the third order 4:2 addition circuits 6a and 6b are added by final product addition circuit 7 and product Z representing the final addition result is output from final addition circuit 7. Generally, the addition circuit increases in bit width with increase in order number.

In the Wallace tree type multiplication apparatus, if the adders are arranged with positions of the digits aligned, interconnection lines intersect at many portions. Referring to FIG. 18, Booth selectors 3a to 3a as well as 4:2 addition circuits 4a to 4g, 5a to 5d, 6a and 6b are all arranged with their one-ends aligned. Thus, an empty region in which interconnection lines are simply arranged is reduced, so that a real estate of the multiplication apparatus is reduced.

In the Wallace tree type multiplication apparatus shown in FIG. 18, the partial products are sequentially halved in number and the number of stages of the addition circuits is considerably reduced as compared with the case of the carry save type multiplication circuit. Accordingly, multiplication can be performed at a higher speed than in the case of the carry save type multiplication apparatus.

In the Wallace tree type multiplication apparatus shown in FIG. 18, the partial products generated by the adders are transmitted in one direction from multiplicand resister circuit 2 toward final addition circuit 7 in FIG. 18. Accordingly, although operations are performed at addition stages in parallel, there is, as indicated by arrows in FIG. 18, a critical path of operations including the path, starting from multiplicand register, of generation of the 0-th order partial product by Booth selector 3a, addition by the first order 4:2 addition circuit 4a, addition by the second order 4:2 addition circuit 5a to produce the second order partial product, addition by the third order 4:2 addition circuit 6a to produce the third order partial product, and transmission to final addition circuit 7. The partial product adder requires at least 54 bits in a transversal direction in FIG. 18. The wiring lines of the critical path pass through 41 stages in total, that is, 27 stages of the Booth selectors, 7 stages of the first order 4:2 addition circuits, 4 stages of the second order 4:2 addition circuits, 2 stages of the third order 4:2 addition circuits, and 1 stage of the final addition circuit.

If the size of the component transistor (a ratio of a channel width to a channel length in the case of an MOS transistor) is increased to generate an output at high speed in each stage, the area of the multiplication array of the multiplication apparatus increases. Thus, the size of the component transistor is the minimum required size to increase integration degree. The third order partial product must be transmitted from the third order 4:2 addition circuit 6a to final addition circuit 7 over a distance of half the length of the multiplication array. A signal propagation delay during the transmission increases, whereby high speed multiplication cannot be achieved.

Further, the 0-th order partial products generated by Booth selectors 3a-3a are added by the addition circuit in each stage. Thus, as the order number of the addition circuit increases, the bit width of the addition circuit also increases. In the case of the 54-bit multiplication apparatus, the bit width of final stage addition circuit 7 is about 80 bits. To make a layout area as small as possible in the multiplication apparatus, one side of the multiplication array is straightly aligned and any protruding portion is laid out on the other side of the multiplication apparatus. As a result, the area of the empty region changes irregularly, not regularly or in the form of monotonous increase or decrease and such. Thus, other circuits cannot be laid out easily and the empty region is left. This reduces layout area efficiency and a highly integrated multiplication apparatus cannot be obtained.

### SUMMARY OF THE INVENTION

An object of the present invention is to provide a Wallace tree type multiplication apparatus capable of performing high speed multiplication.

Another object of the present invention is to provide a Wallace tree type multiplication apparatus with high area efficiency and capable of performing high speed operation.

The multiplication apparatus according to the present invention includes: a Booth encoder for decoding a multi-bit multiplier in accordance with a Booth algorithm to generate a plurality of select control signals; a Booth selection circuits for generating a plurality of partial products using the plurality of select control signals from the Booth encoder and a multi-bit multiplicand; and an intermediate product generating circuit for adding the plurality of partial products in generated by the plurality of Booth selection circuits in a tree-like form and sequentially reducing the number of partial products to generate final intermediate multiplication values. The intermediate product generating circuit has a divided array structure in which an array is divided into two portions at a prescribed bit position of the output from the Booth selection circuits. The divided arrays independently generate final intermediate multiplication values. Each of the divided arrays includes addition circuits in a plurality of stages arranged to perform addition in the tree-like form, and includes a Booth selection circuit.

The multiplication apparatus according to the present invention further includes a final addition circuit for adding final intermediate multiplication values from the intermediate product generating circuits for generating a multiplication value of the multi-bit multiplier and the multi-bit multiplicand.

In the Wallace tree type multiplication apparatus, the multiplication tree array is formed into the divided structure where multiplication is independently performed in each of the divided arrays. Thus, the length of a critical path is reduced for high speed multiplication.

Further, the Booth encoder is efficiently arranged in an irregular region of the addition circuits with varying bit widths, so that the multiplication apparatus with high area efficiency is achieved.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A and 1B are diagrams showing principle arrangement of a multiplication apparatus according to a first embodiment of the present invention.

FIG. 2 is a diagram schematically showing an overall structure of a multiplication apparatus according to a second embodiment of the present invention.

FIG. 3 is a diagram showing an addition tree of a divided array of the multiplication apparatus shown in FIG. 2.

FIG. 4 is a diagram showing bit widths of the addition circuit of a lower divided array and the Booth selector of the multiplication apparatus shown in FIG. 2.

FIGS. 5 to 11 are diagrams schematically showing overall configurations of multiplication apparatuses according to third to ninth embodiments of the present invention.

FIG. 12A is a diagram schematically showing an arrangement of a conventional carry save type parallel multiplication circuit, and FIG. 12B is a diagram schematically showing an arrangement of a multiplication unit circuit shown in FIG. 12A.

FIG. 13 is a diagram schematically showing an arrangement of a conventional carry save addition method based multiplication circuit of an intra-digit skipping addition type.

FIG. 14 is a diagram schematically showing an arrangement of a conventional improved carry save type multiplication circuit.

FIG. 15 is a diagram schematically showing an arrangement of a conventional Wallace tree type multiplication circuit.

FIG. 16 is a diagram schematically showing an arrangement of a Wallace tree portion shown in FIG. 15.

FIG. 17 is a diagram schematically showing an arrangement of an addition circuit shown in FIG. 16.

FIG. 18 is a diagram schematically showing a configuration of a 54-bit multiplication circuit to which the present invention is applied.

### DESCRIPTION OF THE PREFERRED EMBODIMENTS

### First Embodiment

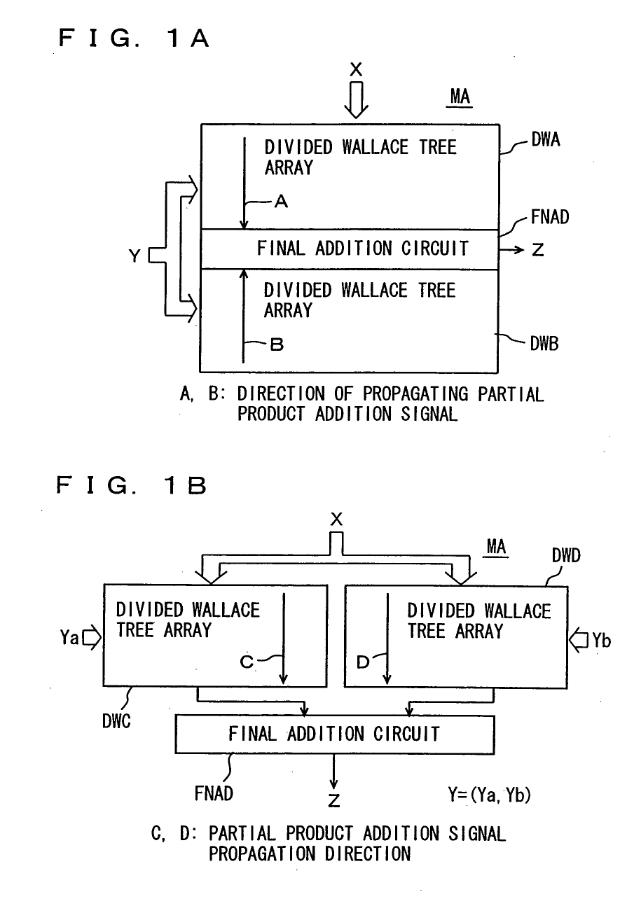

FIG. 1A is a diagram schematically showing an arrangement of a multiplication array of a multiplication apparatus according to the first embodiment of the present invention. Referring to FIG. 1A, a multiplication array MA includes two divided Wallace tree arrays DWA and DWB divided at a specific bit position of multiplier Y. A final addition circuit FNAD is arranged between divided Wallace tree arrays DWA and DWB. Divided Wallace tree arrays DWA and DWB transmit addition results toward final addition circuit FNAD. Thus, the addition circuit stages of the Wallace tree in multiplication array MA are divided by divided Wallace tree arrays DWA and DWB, so that a critical path for transmitting the addition results of partial products is reduced in length for high speed multiplication.

It is noted that the most significant bit of multiplicand X may be on the right or left side of FIG. 1A of divided Wallace tree arrays DWA and DWB. For a multiplier Y, on the other hand, the bits of multiplier Y are arranged from the lower bits to the upper bits in partial product addition signal propagation directions A and B, in divided Wallace tree arrays DWA and DWB, respectively. The stages of the addition circuits of divided Wallace tree arrays DWA and DWB are preferably equal in number. In this case, the critical path is half in length.

Modification

FIG. 1B is a diagram schematically showing a modification of the multiplication apparatus according to the first embodiment of the present invention. Referring to FIG. 1B, multiplication array MA is divided into divided Wallace tree arrays DWC and DWD arranged in parallel with each other in a direction of transmitting the bits of multiplicand X. A final addition circuit FNAD is arranged commonly to divided Wallace tree arrays DWC and DWD.

Divided Wallace tree array DWC multiplies multiplier Ya and multiplicand X, whereas Wallace tree array DWD multiplies multiplier Yb and multiplicand X. Multiplier Y equals to Ya+Yb (bits are divided into two portions with the digits reserved). Preferably, divided Wallace tree arrays DWC and DWD are the same in number of stages of the addition circuits. Partial product addition signals are transmitted in directions indicated by arrows C and D. Therefore, also in this case, the critical path causing signal propagation delay of divided Wallace tree arrays DWC and DWD corresponds to a total length from one-ends to the other ends of arrows C and D shown in FIG. 1B. Accordingly, it is smaller in length than the critical path (approximately corresponding to arrows C+D) of multiplication array MA, so that high speed multiplication is achieved.

It is noted that either of multipliers Ya and Yb may be the upper bits, and the upper bit position of multiplicand X is also arbitrary in FIG. 1B.

As described above, according to the first embodiment of the present invention, multiplication array MA having the Wallace tree structure is divided into divided Wallace tree arrays at a specific bit position of multiplier Y for independent multiplication, and the multiplication results from the divided Wallace tree arrays are added by the final addition circuit. Accordingly, the critical path for signal propagation is reduced in length and a high speed multiplication apparatus is achieved.

### Second Embodiment

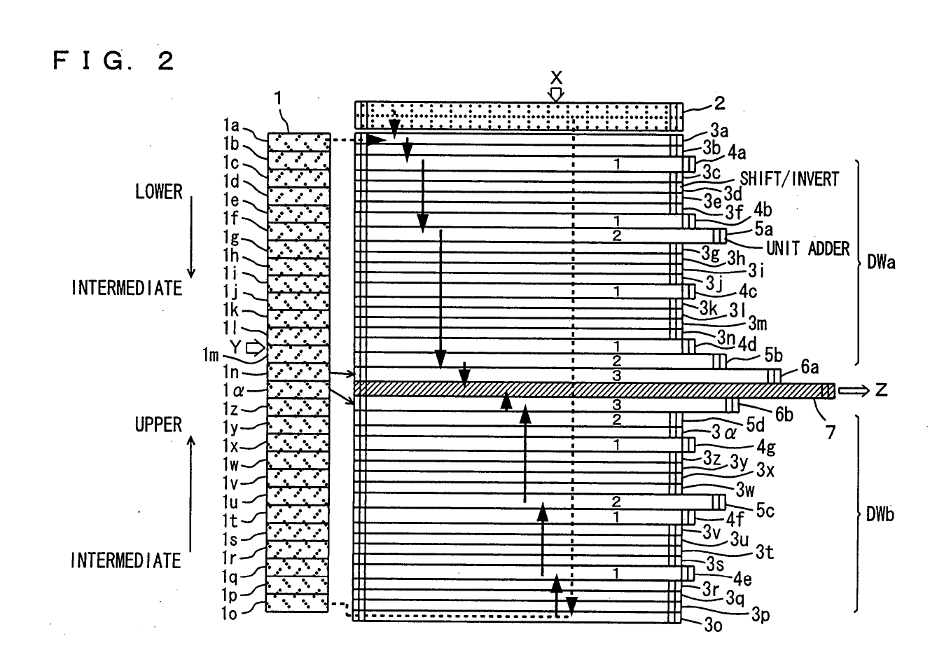

FIG. 2 is a diagram schematically showing a configuration of a multiplication apparatus according to the second embodiment of the present invention. The multiplication apparatus according to the present invention, which will be described with reference to FIG. 2 and the following figures, performs multiplication of 54-bit multiplier Y and 54-bit multiplicand X in accordance with the second order Booth algorithm.

Referring to FIG. 2, a multiplication array is divided into divided arrays DWa and DWb. Divided array DWa includes: Booth selectors 3a to 3n generating the 0-th order partial products from multiplicand data from a multiplicand register circuit 2 in accordance with select control signals from Booth encode circuits 1a to in included in a Booth encoder 1; the first order 4:2 addition circuits 4a to 4d adding the 0-th order partial products generated by Booth selectors 3a to 3n for generating the first order partial products; the second order 4:2 addition circuits 5a and 5b adding the first order partial products generated by the first order 4:2 addition circuits 4a to 4d for generating the second order partial products; and the third order 4:2 addition circuit 6a adding the second order partial products from the second order 4:2 addition circuits 4b to 4d for generating the third order partial product. In divided Wallace tree array DWa, shift circuits/inverter circuits of Booth selectors 3a to 3n are represented by small rectangulars. Unit adders are also represented by small rectangulars in addition circuits 4a to 4d, 5a, 5b and 6a.

Booth encoder 1 generates select control signals in accordance with the second order Booth algorithm. Thus, 27 Booth encode circuits 1a to 1a are arranged for 54-bit multiplier Y. In Booth encoder 1, bit positions of multiplier Y are reversed with respect to Booth encoder circuit in. More specifically, Booth encode circuit 1a-1n are arranged corresponding to the lower bit to the intermediate bit of multiplier Y, respectively. On the other hand, in divided array DWb, Booth encode circuits 1o-1α are reversed in position and arranged corresponding to the intermediate bit to the upper bit from the lower to the upper portion, respectively.

Divided array DWb includes: Booth selectors 3o to 3a arranged corresponding to Booth encode circuits 1o-1a for generating the 0-th order partial products of a multi-bit multiplicand X from a multiplicand register circuit 2 in accordance with select control signals from corresponding Booth encode circuits; the first order 4:2 addition circuits 4e to 4g adding the 0-th order partial products from Booth selectors 3o to 3a for generating the first order partial products; the second order addition circuits 5c and 5d adding the first order partial products generated by the first order 4:2 addition circuits 4e to 4g for generating the second order partial products; and the third order addition circuit 6b adding the second order partial products generated by the second order 4:2 addition circuits 5c and 5d for generating the third order partial products.

A final addition circuit 7 is arranged between divided arrays DWa and DWb, and a multiplication result Z is output from final addition circuit 7.

Here, the second order 4:2 addition circuit 5d is almost the same in bit width as Booth selector 3α for the following reason. When the partial products down to the second order partial products are sequentially compressed in a ratio of 4:2, Booth selector 3a generates the first order partial product only by means of interconnection lines. In the second order Booth algorithm, the 0-th order partial products are different in position of digit by 2 bits. Thus, when the first order partial product generated by the first order 4:2 addition circuit 4g and the 0-th order (pseudo first order) partial product generated by Booth selector 3α are added, there is a digit for which addition is not needed in the second order 4:2 addition circuit 5d. The digit is merely formed of an interconnection line and an adder is not arranged. Accordingly, the second order 4:2 addition circuit 5d is smaller in size than the other second 4:2 addition circuits. This will be described in detail afterwards.

In the multiplication array, Booth selectors 3a to 3α as well as 4:2 addition circuits 4a to 4g, 5a-d, 6a, 6b and 7 are arranged. As indicated by arrows, the critical path for signal propagation in divided array DWa causes a delay which is equal to a sum of a time required for transmitting a signal from Booth encode circuit 1a to all shift/inverters of Booth selector 3a, a time required for generating the 0-th order partial products in Booth selector 3a, a time required for adding the 0-th order partial products by the first order 4:2 addition circuit 4a for generating the first order partial products, a time required for adding the first order partial products by the second order 4:2 addition circuit 5a for generating the second order partial products, a time required for adding the second order partial product by the third order 4:2 addition circuit 6a for generating the third order partial product, and a time required for the third order partial product to be transmitted to the final addition circuit.

On the other hand, the critical path for signal propagation in divided array DWb causes a delay, as indicated by arrows, which is a sum of a time required for transmitting select control signals from Booth encode circuit 1o and multiplicand X data from multiplicand register circuit 2 to Booth selector 3o, a time required for generating the 0-th order partial products by Booth selector 3o for transmission to the first order 4:2 addition circuit 4e, a time required for generating the first order partial products from the first order 4:2 addition circuit 4e for transmission to the second order 4:2 addition circuit 5c, a time required for generating the second order partial products by the second order 4:2 addition circuit 5c for transmission to the third order 4:2 addition circuit 6b, and a time required for generating the third order partial product by the third order 4:2 addition circuit 6b for transmission to the final addition circuit 7. In the divided array configuration, the critical path is considerably reduced in length as compared with the configuration shown in FIG. 18 of the prior art. In addition, a distance from the third order 4:2 addition circuits 6a and 6b to final addition circuit 7 is reduced, so that a final product Z can be produced by final addition circuit 7 at high speed.

In other words, Booth encoder 1 is almost bisected, and divided arrays DWa and DWb of the multiplication array have bisected structures of the multiplication array. Thus, the interconnection line length of the critical path for signal propagation can be made half that of the multiplication array shown in FIG. 18, so that the multiplication result can be produced at high speed.

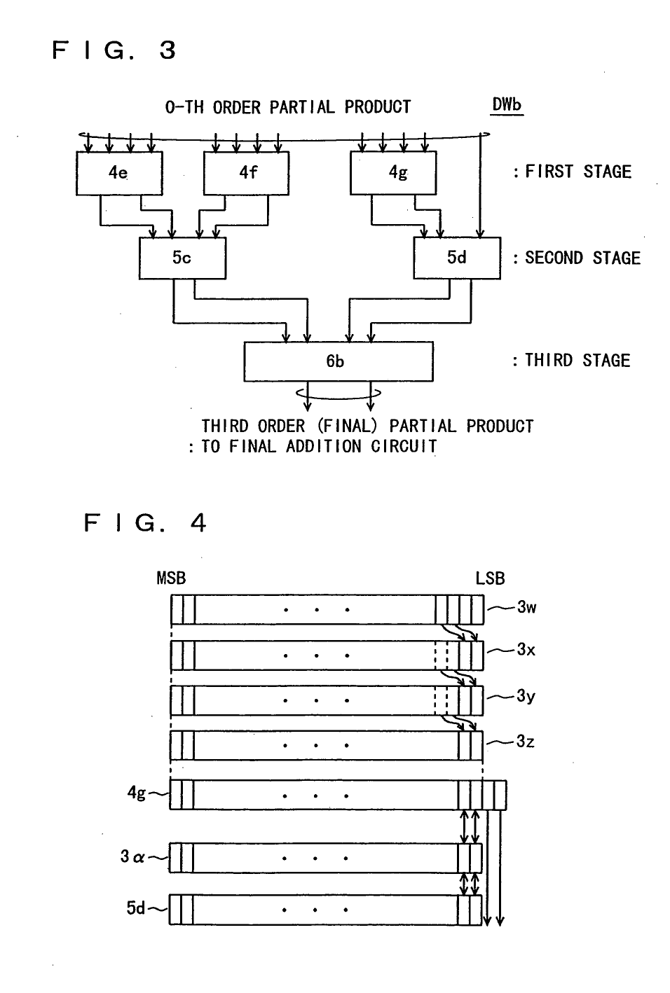

FIG. 3 is a diagram schematically showing a Wallace tree configuration of divided array DWb shown in FIG. 2. Referring to FIG. 3, the 0-th order partial products generated by Booth selectors 3o to 3α in divided array DWb are added by the first stage addition circuits 4e, 4f and 4g. The first order partial products generated by the first stage addition circuits 4e and 4f are added by the second stage addition circuit 5c. The second stage addition circuit 5d adds the 0-th order partial product and addition results generated by the first stage addition circuit 4g.

The second order partial products generated by these second stage addition circuits 5c and 5d are added by the third stage addition circuit 6b to produce the third order partial product (the final partial product).

As described above, because of such addition in a tree-like form, the numbers of partial products generated as the 0-th order partial products to the first, second and third order partial products are sequentially reduced, to reduce the number of stages of the addition circuits, so that reduction in length of the carry propagation path is achieved. Addition operations are performed in parallel in respective stages.

FIG. 4 is a diagram schematically showing a configuration of partial products applied to the second stage addition circuit 5d. FIG. 4 exemplifies the partial products aligned on the side of the most significant bit MSB. The 0-th order partial products are generated by Booth selectors 3w to 3z (see FIG. 18). In the second order Booth algorithm, the partial products are different in bit position by 2 bits one another. As a result, the 0-th order partial products generated by Booth selectors 3w, 3×, 3y and 3z are different in position by two digits each other. During an adding operation, the positions of the digits are aligned for the adding operation. Addition circuit 4g has a bit width which is greater by two bits than Booth selectors 3w to 3z. On the other hand, the 0-th order partial product generated by Booth selector 3a is a partial product upper by two digits than the 0-th order partial product generated by Booth selector 3z. Accordingly, in the first stage addition circuit (the first order 4:2 addition circuit) 4g, if only two inputs are applied to the 4:2 addition circuit not having a corresponding digit at a lower position, such two inputs are directly output through merely arranged interconnection lines. Thus, in the second stage addition circuit 5d, the 4:2 adder is arranged corresponding to each digit position of Booth selector 3α, and the 0-th order partial product generated by the first stage addition circuit 4g and that generated by Booth selector 3α are added. Accordingly, there is a digit for which addition is not required by the second stage 4:2 addition circuit 5d (the second stage addition circuit), so that the bit width of the second order 4:2 addition circuit 5d is made the same as that of Booth selector 3α in the multiplication array. Thus, the bit width of the multiplication array is reduced as small as possible. However, generally, in the Wallace tree method, the bit width of the addition result increases as addition proceeds in the tree-like form. Thus, as shown in FIG. 2; the widths of the addition circuits in the horizontal direction are irregularly different in the multiplication array.

As described above, according to the second embodiment of the present invention, the Wallace tree type multiplication array is divided into two portions, each of which is independently subjected to multiplication. Thereafter, the final addition is performed. Thus, an interconnection line length of the critical path for signal propagation is halved for high speed multiplication.

### Third Embodiment

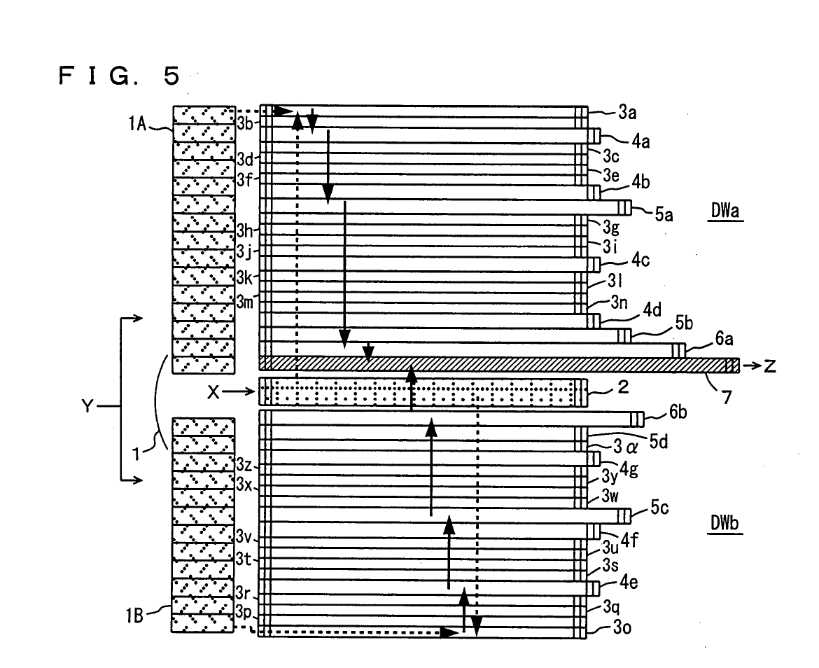

FIG. 5 is a diagram schematically showing a configuration of an array portion of a multiplication apparatus according to the third embodiment of the present invention. Referring to FIG. 5, in the multiplication apparatus, the multiplication array is divided into two divided arrays DWa and DWb. A final addition circuit 7 is arranged between divided arrays DWa and DWb. This configuration is the same as in the second embodiment described with reference to FIG. 2. In the third embodiment, a multiplicand register circuit 2 is arranged adjacent to final addition circuit 7 between divided arrays DWa and DWb, receives a multiplicand X and applies multiplicand data to Booth selectors 3a to 3a. Thus, multiplicand register circuit 2 transmits the multiplicand data in the opposite directions for divided arrays DWa and DWb.

Corresponding to divided arrays DWa and DWb, Booth encoder 1 is also divided into two divided encoders 1A and 1B.

In the configuration shown in FIG. 5, as indicated by arrows, a critical path in divided array DWa is as follows. In the critical path, multiplicand data is transmitted from multiplicand register circuit 2 to Booth selector 3a, the 0-th order partial product is generated by Booth selector 3a, and the 0-th order partial product is transmitted to the first order 4:2 addition circuit 4a. Further, in the critical path, the first order partial product is generated by the first order 4:2 addition circuit 4a to be transmitted to the second order 4:2 addition circuit 5a, the second order partial product generated by the second order 4:2 addition circuit 5a is applied to the third order 4:2 addition circuit 6a, and the third order partial product is generated by the third order 4:2 addition circuit 6a to be applied to final addition circuit 7.

On the other hand, in the critical path in divided array DWb, the multiplicand data from multiplicand register circuit 2 is transmitted to Booth selector 3o, the 0-th order partial product is generated by Booth selector 3o in accordance with the corresponding select control signals from divided Booth encoder 1B, the 0-th order partial product is transmitted to the first order 4:2 addition circuit 4e, the first order partial product from the first order 4:2 addition circuit 4e is transmitted to the second order 4:2 addition circuit 5c, the second order partial product from addition circuit 5c is transmitted to the third order 4:2 addition circuit 6b, and the third order partial product is generated by the third order 4:2 addition circuit 5d to be transmitted to final addition circuit 7.

In the divided array configuration shown in FIG. 5, the multiplicand data from multiplicand register circuit 2 are only transmitted to divided arrays DWa and DWb. As a result, a time required for transmitting the multiplicand data to Booth selectors 3a to 3α can be reduced, and reduction in signal propagation delay is achieved. Accordingly, a multiplication result Z can be obtained through high speed multiplication. The other parts of the structure are the same as in FIG. 2.

As described above, according to the third embodiment of the present invention, the multiplicand register circuit is arranged adjacent to the final addition circuit between the divided arrays. Thus, an interconnection line length of the multiplicand data transmitting path is reduced, and a shortening in critical path for signal propagation can be achieved for high speed operation.

### Fourth Embodiment

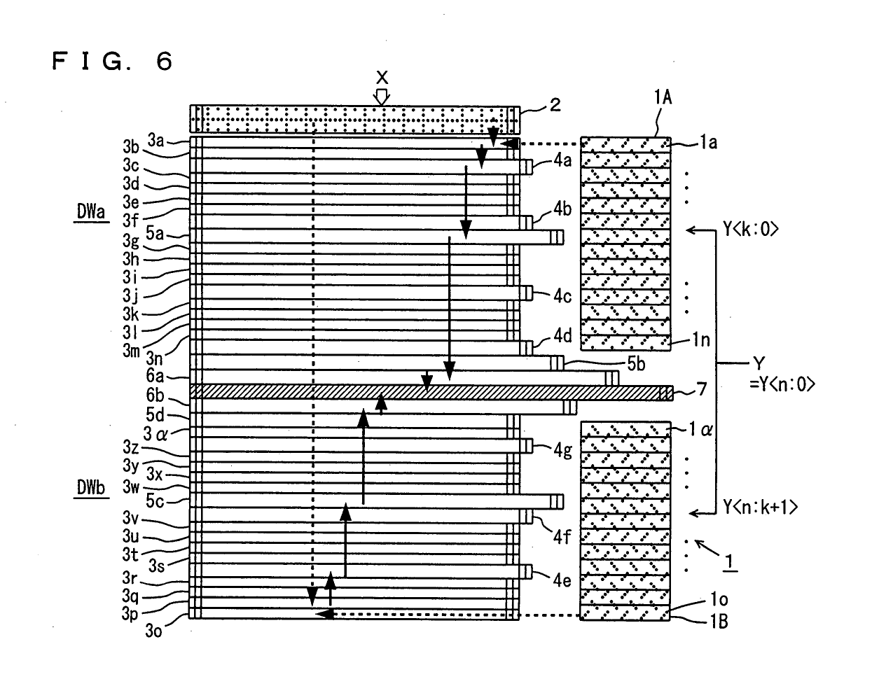

FIG. 6 is a diagram schematically showing a configuration of a multiplication apparatus according to the fourth embodiment of the present invention. As in the above described first embodiment shown in FIG. 2, in the configuration shown in FIG. 6, a multiplication array is divided into divided arrays DWa and DWb at a prescribed bit position of multiplier Y. A final addition circuit 7 is arranged between divided arrays DWa and DWb.

In divided arrays DWa and DWb, Booth selectors 3a to 3a, the first order 4:2 addition circuits 4a to 4g, the second order 4:2 addition circuits 5a to 5d, the third order 4:2 addition circuits, and final addition circuit 7 are arranged with respective one-ends aligned. As an addition signal is propagated through a Wallace tree, a bit width of the addition circuit increases.

However, if the first, second and third order 4:2 addition circuits are arranged in this order in the propagation direction of the signal indicating the addition result as in divided arrays DWa and DWb, rather than sequentially arranging the first, second and third stage addition circuits, the width of the addition circuits irregularly varies. Divided Booth encoders 1a and 1b are arranged corresponding to divided arrays DWa and DWb in the protruding region of the addition circuits. Divided Booth encoders 1a and 1b are arranged with final addition circuit 7 interposed therebetween.

In the divided array configuration, the final addition circuit is arranged in the middle portion (a boundary region of the divided arrays), and final partial product generating circuits (the third stage addition circuits) are arranged on either side of final addition circuit 7. Thus, the protruding portions of the addition circuits in the divided arrays concentrate in the middle region of the multiplication array. Divided Booth encoders 1a and 1b are arranged adjacent to the region, so that Booth encoder 1 can be arranged in accordance with the sizes of Booth encode circuits 1a to 1a. As a result, a small multiplication apparatus with efficiently utilized protruding region can be achieved.

In the case of the bisected configuration, divided arrays DWa and DWb are axially symmetric about final addition circuit 7, thereby facilitating layout of the addition circuits. In addition, since the protruding region is also axially symmetric, divided Booth encoders 1a and 1b are readily arranged.

As described above, according to the fourth embodiment of the present invention, the divided Booth encoders are arranged adjacent to the protruding region of the addition circuits, so that a small multiplication apparatus can readily be achieved with high area efficiency. In addition, an effect similar to that of the first embodiment can be provided.

It is noted that, also in the fourth embodiment, the most and least significant bits may be on any of the sides of a multiplicand register circuit 2 receiving a multiplicand X. For multiplier Y (Y<n:0>), multiplier data Y<k:0> and Y<n:k+1> are respectively applied to divided Booth encoders 1A and 1B. The number of multiplier data bits received by each Booth encoder circuit varies according to the order number of the Booth algorithm used. In the present embodiment, the second order Booth algorithm is used, and multiplier data of 3 bits is applied to each of Booth encode circuits 1a to 1a. In this case, upper and lower bit positions with respect to divided Booth encoder 1B are changed by interconnection lines.

### Fifth Embodiment

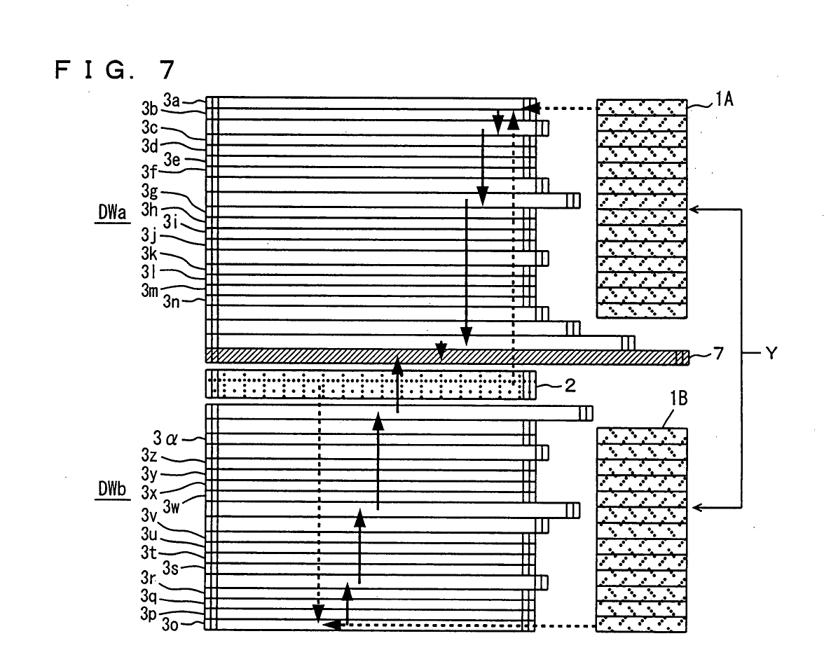

FIG. 7 is a diagram schematically showing a configuration of a multiplication apparatus according to the fifth embodiment of the present invention. As in the above described third embodiment, in the multiplication apparatus shown in FIG. 7, a multiplicand register circuit 2 is arranged adjacent to final addition circuit 7 between divided arrays DWa and DWb. In divided arrays DWa and DWb, Booth selectors 3a to 3a and the first to the third stage addition circuits are arranged with respective one-ends aligned. In the region in which the other ends of the addition circuits are arranged, divided Booth encoders 1A and 1B are arranged corresponding to divided arrays DWa and DWb, respectively. Divided Booth encoders 1A and 1B are arranged with final addition circuit 7 interposed therebetween. In the configuration shown in FIG. 7, in addition to the effect of the above described third embodiment, the following effect is obtained. More specifically, divided Booth encoders 1A and 1B are arranged in the region in which the addition circuits irregularly protrude, with the Booth encode circuits of divided Booth encoders 1A and 1B made the same in size. In addition, the divided arrays are axially symmetric about final addition circuit 7, so that the layout is simplified. Accordingly, a small multiplication apparatus capable of performing a high speed operation is achieved with high area efficiency.

### Sixth Embodiment

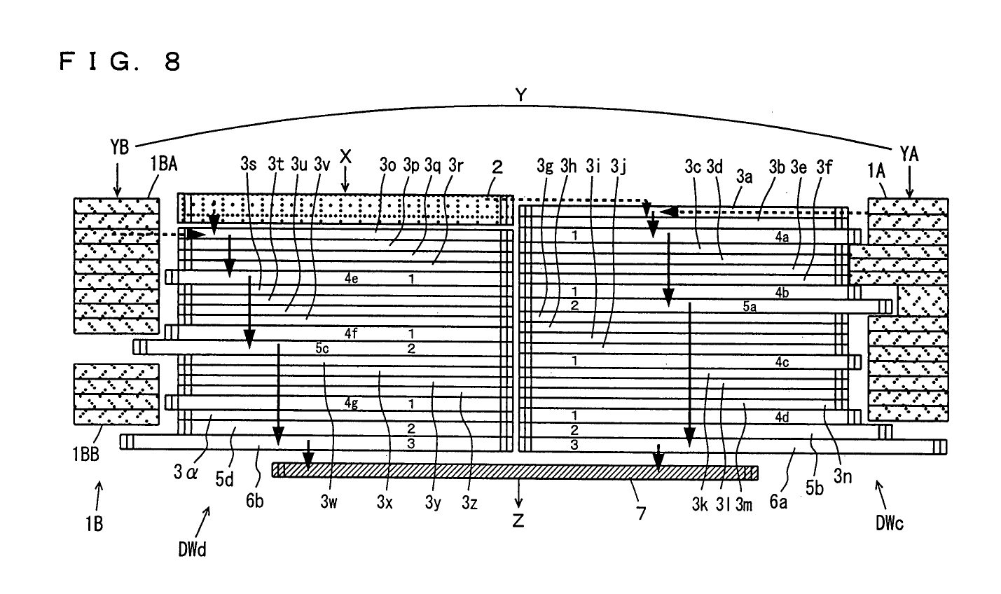

FIG. 8 is a diagram schematically showing a configuration of a multiplication apparatus according to the sixth embodiment of the present invention. Referring to FIG. 8, a multiplication array is divided into two divided arrays DWc and DWd arranged in parallel with each other. Divided array DWc includes Booth selectors 3a to 3n, the first order 4:2 addition circuit 4a, the second order 4:2 addition circuit 5a, and the third order 4:2 addition circuit 6a. Divided array DWd includes Booth selectors 3o to 3α, the first order 4:2 addition circuits 4e to 4g, the second order 4:2 addition circuits 5c and 5d, and the third order 4:2 addition circuit 6b. In divided arrays DWc and DWd, the Booth selectors and 4:2 addition circuits are arranged with their ends aligned in a boundary region of the divided arrays.

A multiplicand register circuit 2 is arranged facing to Booth selector 3o of divided array DWd, and data of multiplicand X is commonly applied to divided arrays DWd and DWc.

Booth encoder 1 is divided into two divided Booth encoders 1A and 1B corresponding to the parallel arrangement of divided arrays DWc and DWd. Divided Booth encoder 1A is arranged facing to the region in which the addition circuits of divided array DWc protrudes. As for divided Booth encoder 1A, the second order 4:2 addition circuit 5a is larger in bit width than the Booth selector. To prevent contact with the second order 4:2 addition circuit 5a, the width of the Booth encode circuit is increased in a longitudinal direction in the region in which the Booth encode circuit is facing to addition circuits 4b and 5a. In addition, the Booth encoder is increased in width in the region in which the Booth encoder is facing to the Booth selector between the first order 4:2 addition circuits 4a and 4b. The Booth encode circuit 1A is laid out fitting to the shape of the protruding region of divided array DWc, and the Booth encode circuits are arranged facing to the Booth selectors.

On the other hand, divided Booth encoder 1B is further divided into sub divided Booth encoders 1BA and 1BB with the second order 4:2 addition circuit 5c interposed therebetween. In divided array DWd, the second order 4:2 addition circuit 5c is the same in bit width as the Booth selector, and the region facing to the second order 4:2 addition circuit 5c can be utilized as a region for the Booth encode circuit. Accordingly, in divided Booth encoder 1B, the Booth encode circuits are all the same in size, and circuit cells having a basic layout are regularly arranged. Thus, design and layout are simplified. In addition, divided sub Booth encoders 1BA and 1BB are arranged with the second order 4:2 addition circuit 5c interposed therebetween. As a result, the Booth encoder is efficiently arranged while utilizing the protruding region of the addition circuits of divided array DWb. Accordingly, the multiplication apparatus with no protruding region and with a small circuit real estate is achieved.

In divided array DWb, one-ends of Booth selectors 3o to 3a and the addition circuits are aligned in a boundary region of the divided arrays.

To avoid protrusion of multiplicand register circuit 2 as much as possible, multiplicand register circuit is arranged facing to divided Booth encoder 1B with reduced length and increased width.

A final addition circuit 7 is arranged commonly to divided arrays DWd and DWc.

In the configuration of the multiplication apparatus shown in FIG. 8, signals propagate in the same direction in divided arrays DWd and DWc, and the addition result is transmitted toward final addition circuit 7. However, divided arrays DWc and DWd independently perform partial product addition operations, and the critical path of the apparatus as a whole is provided by the critical path each of divided arrays DWc and DWd. Accordingly, in the parallel arrangement of divided arrays DWd and DWc, an interconnection line length of the critical path is halved as compared with the conventional apparatus, so that high speed multiplication can be achieved.

It is noted that, in the configuration shown in FIG. 8, any of partial multipliers YA and YB of multiplier Y may be at the upper bits, and may be on the side of the upper bits in multiplicand register circuit 2. Divided Booth encoders 1A and 1B each have the upper bit position arranged close to final addition circuit 7.

As described above, according to the sixth embodiment of the present invention, the multiplication array is divided into parallel divided arrays, and the divided Booth encoders are arranged facing to the protruding region of the addition circuits of the divided arrays. Thus, the critical path is halved in length and the multiplication apparatus for high speed multiplication is achieved. In addition, the divided encoders are arranged with their one-ends aligned in the protruding region of the divided arrays, so that the multiplication apparatus with high area efficiency and small circuit real estate is achieved.

### Seventh Embodiment

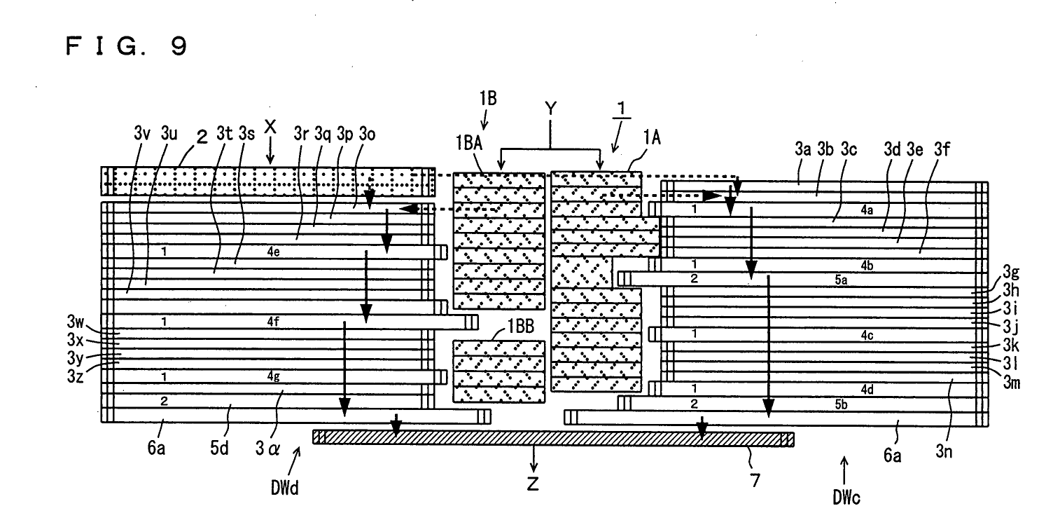

FIG. 9 is a diagram schematically showing a configuration of a multiplication apparatus according to the seventh embodiment of the present invention. A multiplication array is divided into divided arrays DWc and DWd, which are arranged in parallel with each other also in FIG. 9. A multiplicand register circuit 2 is arranged facing to a Booth selector 3o of divided array DWd, and data of multiplicand X is commonly applied to divided arrays DWc and DWd. Divided arrays DWc and DWd are arranged with their opposing ends (the ends far from a boundary region) aligned. More specifically, in divided array DWc, Booth selectors 3a to 3n, 4:2 addition circuits 4a to 4d, 5a, 5b and 6a have the ends far from the boundary region aligned. A protruding region of the addition circuits is in the boundary region of the divided array. Similarly, in divided array DWd, the Booth selectors 3o to 3α, 4:2 addition circuits 4e to 4g, 5d and 6a have the ends far from the boundary region of the divided arrays arranged in alignment. The protruding region of the addition circuits is in the boundary region between the divided arrays. Divided Booth encoders 1A and 1B are arranged, in the boundary region of the divided arrays, facing to divided arrays DWc and DWd, respectively. As in the configuration of the above described FIG. 8, divided Booth encoder 1A has its Booth encode circuits laid out according to the irregular protruding region of divided array DWc. Accordingly, divided Booth encoder 1A has a recessed region corresponding to the protruding region, and has the protruding region corresponding the recessed region of divided array DWc.

On the other hand, divided Booth encoder 1B arranged in the boundary region of the divided arrays is further divided into sub Booth encoders 1BA and 1BB with the first order 4:2 addition circuit 4f interposed therebetween. The mutually facing ends of divided Booth encoders 1A and 1B are aligned.

The configuration of divided arrays DWc and DWd shown in FIG. 9 is the same as that shown in FIG. 8, where an interconnection line length of a critical path is reduced for high speed multiplication.

Since Booth encoder 1 is arranged in the boundary region between the divided arrays, the interconnection lines for transmitting data of multiplier Y can be laid concentrated in the boundary region, so that the layout of the signal lines for transmitting data bits of multiplier Y is simplified.

In addition, divided arrays DWc and DWd have the ends opposite to the boundary region arranged aligned, whereby an empty region in the multiplication apparatus is reduced to achieve the multiplication apparatus with high area efficiency.

### Eighth Embodiment

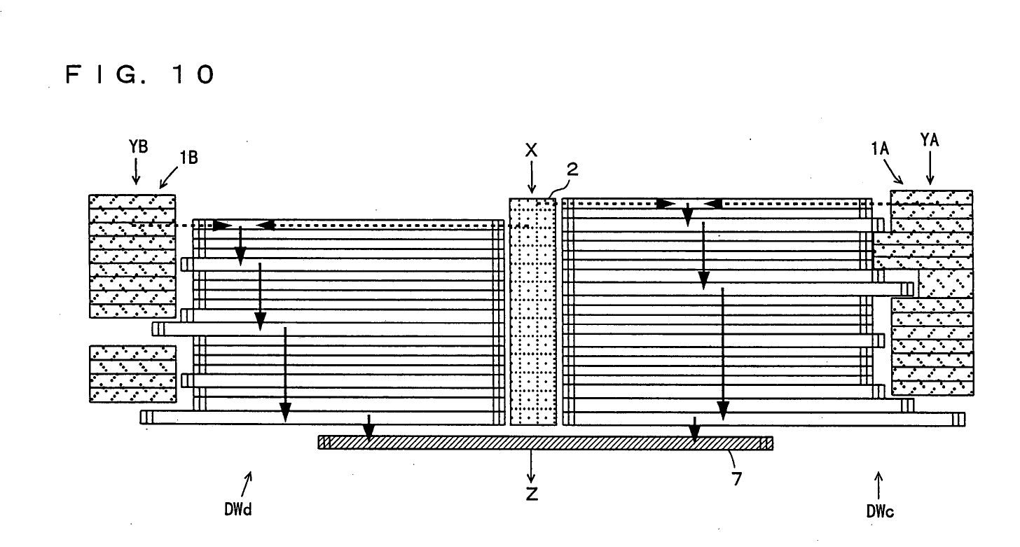

FIG. 10 is a diagram schematically showing an overall configuration of a multiplication apparatus according to the eighth embodiment of the present invention. The multiplication apparatus shown in FIG. 10 is different from that shown in FIG. 8 in the following respect. More specifically, a multiplicand register circuit 2 for storing multiplicand X data is arranged in the region between divided arrays DWc and DWd. Multiplicand register circuit 2 has a divided structure having registers so arranged in a plurality of columns (two columns) as to align divided arrays DWc and DWd in a height direction as much as possible.

The other parts of the configuration are the same as in FIG. 8.

According to the configuration shown in FIG. 10, the interconnection line lengths from multiplicand register circuit 2 to the Booth selectors in divided arrays DWc and DWd are made equal. Accordingly, the interconnection line delays of the critical paths (indicated by arrows in the figure) in divided arrays DWc and DWd are made equal, so that the interconnection line lengths of the critical paths of divided arrays DWc and DWd are substantially made equal (if bisected) for high speed multiplication. Further, an effect similar to that of the multiplication apparatus shown in FIG. 8 is provided.

### Ninth Embodiment

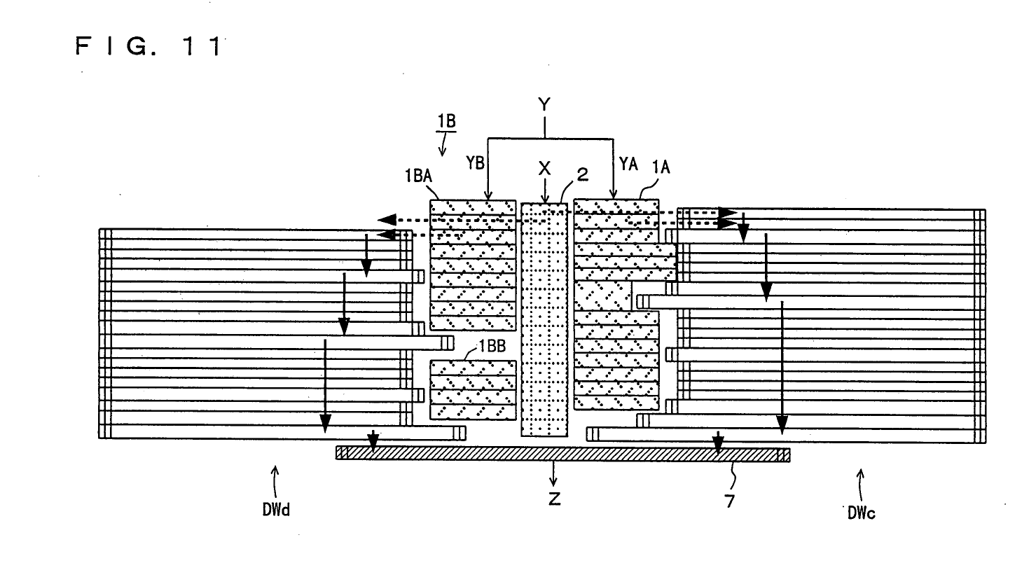

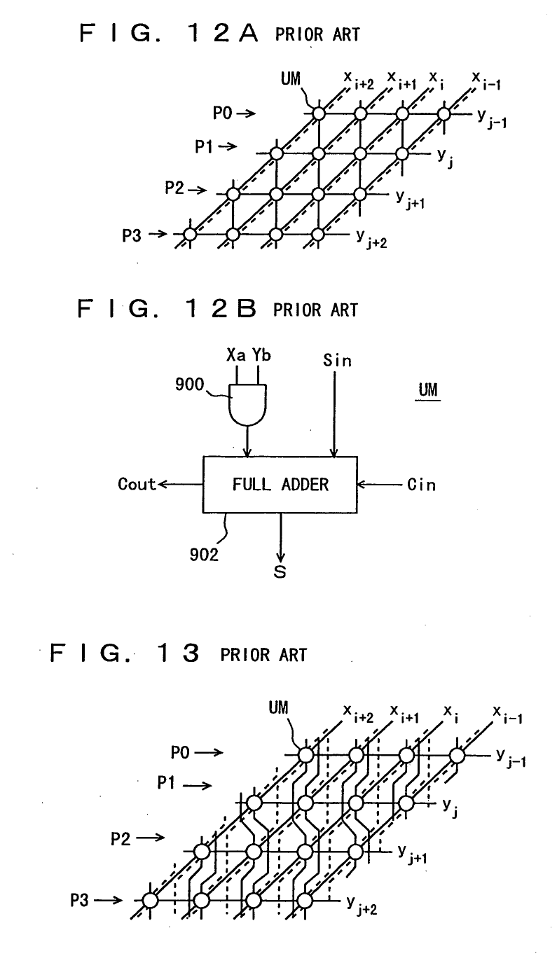

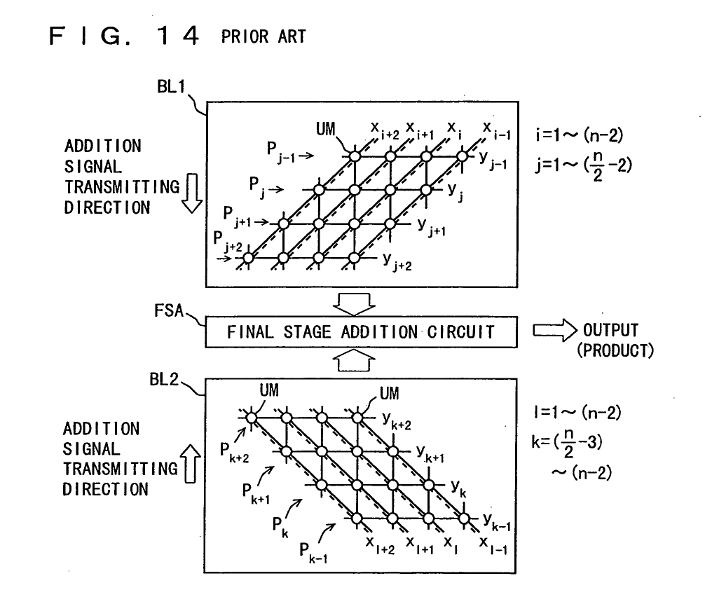

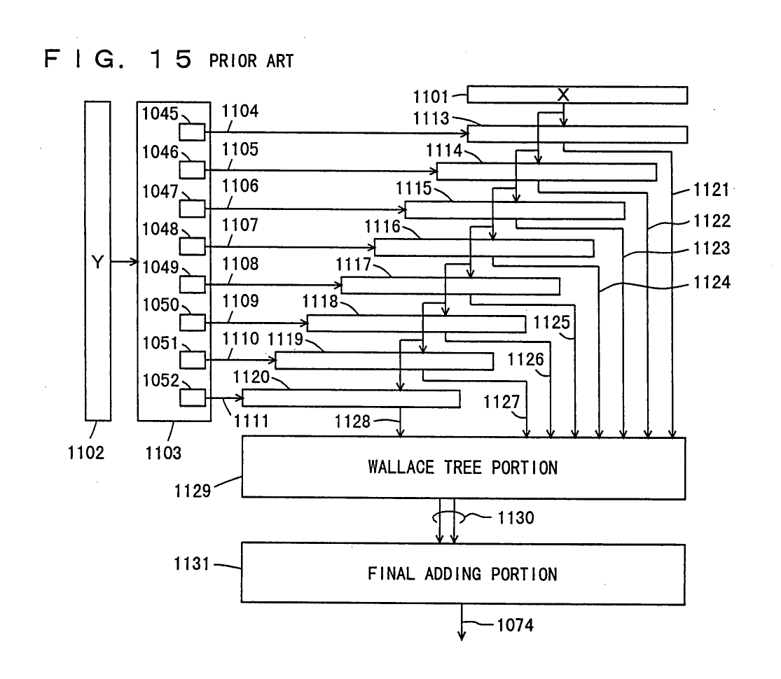

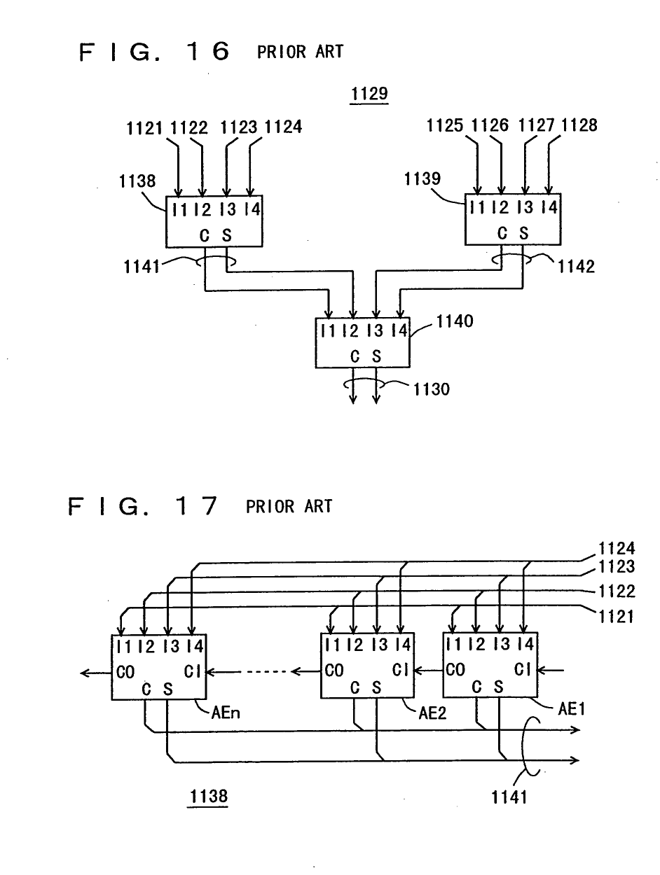

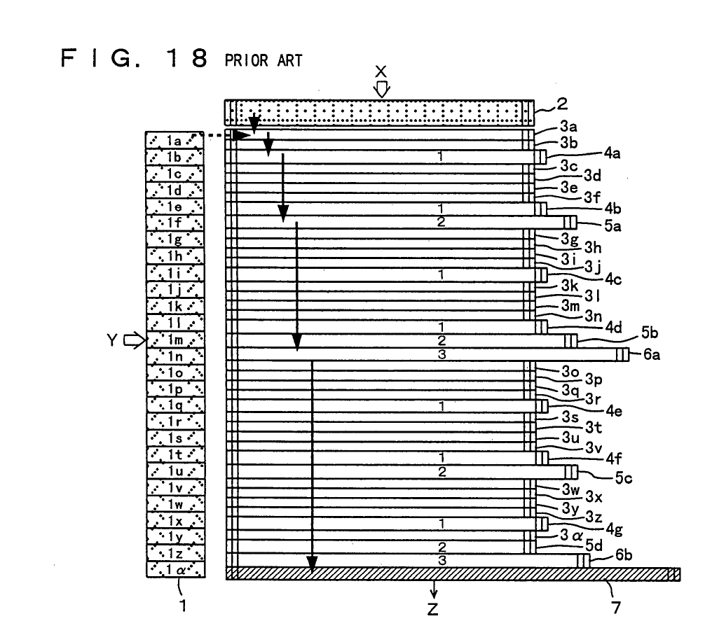

FIG. 11 is a diagram schematically showing an overall configuration of a multiplication apparatus according to the ninth embodiment of the present invention. The multiplication apparatus shown in FIG. 11 is different from that shown in FIG. 9 in the following respect. More specifically, a multiplicand register circuit 2 is arranged between divided Booth encoders 1A and 1B in the boundary region between divided arrays DWd and DWc. Multiplicand register circuit 2 includes registers (those for storing bits of multiplicand X) arranged in a plurality of columns (two columns) to be aligned with divided arrays DWc and DWd in a height direction. The other parts of the configuration are the same as in FIG. 9.

In the configuration shown in FIG. 11, output data bits of multiplicand register circuit 2 for storing multiplicand X data are the same in interconnection line length or propagation time to divided arrays DWc and DWd. Accordingly, if divided arrays DWc and DWd are formed through approximate bisection, the interconnection line lengths of the critical paths of divided arrays DWc and DWd are substantially made equal to eliminate any delay in operation (adjustment of timing or the like) caused by a difference in interconnection line lengths of the critical paths. Thus, the multiplication apparatus for high speed multiplication can be achieved. In addition, an effect similar to that of the above described configuration shown in FIG. 9 can be provided.

Other Application

In the above described embodiments, the second order Booth algorithm is used. However, any other order Booth algorithm, for example the third order Booth algorithm, may be used.

In addition, the arrangements of the Booth encoder and the multiplicand register can be applied to a multiplication apparatus using only a Wallace tree and not using the Booth algorithm.

When the divided arrays are arranged in parallel with each other as in the case of the sixth to the ninth embodiments, the produced partial products may have the upper bit positions at any side thereof. The ends of the circuits may be aligned on any of the least and the most significant bit sides. In divided arrays DWd and DWc, an addition result (a product) Z is produced in final addition circuit 7, so that the bit positions of the partial products are translated (parallel-shifted) rather than axially symmetric. In other words, one and the other divided arrays has the least and the most significant bit positions placed facing to the array boundary region, respectively, and are reversed in those bit positions at the opposite sides.

The position of the multiplier bit at which the array is divided, is arbitrary as long as the critical path is shortened.

As in the foregoing, according to the present invention, the critical path of the multiplier apparatus can be reduced in length by the divided arrays, so that the multiplication apparatus for high speed multiplication can be achieved. In addition, the divided array configuration enables regular distribution of the protruding portions of partial product addition circuits. The Booth encoder can readily be laid out in the protruding region, whereby the multiplication apparatus can be reduced in size.

Although the present invention has been described and illustrated in detail, it is clearly understood that the same is by way of illustration and example only and is not to be taken by way of limitation, the spirit and scope of the present invention being limited only by the terms of the appended claims.

1-5. (canceled)

6. A multiplication apparatus for multiplying a multi-bit multiplier and a multi-bit multiplicand comprising: according to claim 1,
a Booth encoder for encoding said multiplier in accordance with a Booth algorithm for generating a plurality of select control signals;
Booth selection circuitry for generating a plurality of partial products in accordance with said plurality of select control signals received from said Booth encoder and said multi-bit multiplicand;
intermediate product generating circuitry for adding said plurality of partial products generated by said Booth selection circuitry in a tree-like form and sequentially reducing a number of said partial products to generate final intermediate multiplication values said intermediate product generating circuitry having a divided array arrangement of being divided into two divided arrays at a prescribed bit position of said multi-bit multipliers said two divided arrays independently generating said final intermediate multiplication values respectively, and each of the divided arrays including a plurality of stages of addition circuits arranged to perform addition in said tree-like form and a Booth selection circuit of said Booth selection circuitry and
a final addition circuit for adding said final intermediate multiplication values from said intermediate product generating circuitry for generating a multiplication value of said multi-bit multiplier and said multi-bit multiplicand
wherein said divided arrays are arranged in a direction in which said plurality of select control signals are transmitted, and each of said divided arrays includes the addition circuits arranged in the plurality of stages for adding the partial products in a tree-like form in a same direction.

7. The multiplication apparatus according to claim 6, wherein said Booth encoder is divided to be arranged facing to each of said divided arrays.

8. The multiplication apparatus according to claim 7, wherein each of said divided arrays includes the addition circuits in the plurality of stages having different bit widths,
said addition circuits in said plurality of stages have their one-ends aligned, and
the Booth encoder is arranged on a side of other ends of said addition circuits in said plurality of stages.

9. The multiplication apparatus according to claim 8, wherein said Booth encoder is arranged on opposite sides with respect to said divided arrays.

10. The multiplication apparatus according to claim 8, wherein said Booth encoder is arranged between said divided arrays.

11. The multiplication apparatus according to claim 6, further including a multiplicand data generating circuit for applying said multi-bit multiplicand to said Booth selection circuitry, wherein
said multiplicand data generating circuit is arranged commonly to said divided arrays and
facing to one of said divided arrays.

12. The multiplication apparatus according to claim 6, further including a multiplicand data generating circuit for applying said multi-bit multiplicand to said Booth selection circuitry, wherein
said multiplicand data generating circuit is arranged in a region between said divided arrays.

13. The multiplication apparatus according to claim 9, further including a multiplicand data generating circuit for applying said multi-bit multiplicand to said Booth selection circuitry, wherein
said multiplicand data generating circuit is arranged between said divided arrays.

14. The multiplication apparatus according to claim 10, further including a multiplicand data generating circuit for applying said multi-bit multiplicand to said Booth selection circuitry, wherein
said multiplicand data generating circuit is arranged, adjacent to said Booth encoder, between said divided arrays.

15. The multiplication apparatus according to claim 12, wherein said multiplicand generating circuit is so formed into a divided structure as to have a height according to a height of said divided arrays in a direction orthogonal to a direction in which the select control signals are transmitted.

16. The multiplication apparatus according to claim 6, wherein said final addition circuit is arranged commonly to said divided arrays for adding the final intermediate multiplication values from said divided arrays and producing a final product as said multiplication value.
